(19) United States
(12) Patent Application Publication
(10) Pub. No.: US 2005/0203905 A1
(43) Pub. Date: Sep. 15, 2005

(54) Method of synchronizing data between server and user terminal using messenger service system and system using the same

(75) Inventors: Ho-Won Jung, Suwon-si (KR); Jee-Hoon Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/077,755

(22) Filed: Mar. 11, 2005

(30) Foreign Application Priority Data
Mar. 12, 2004 (KR) 16835/2004
Sep. 9, 2004 (KR) 72097/2004

(51) Int. Cl. G06F 17/30

(52) U.S. Cl. 707/8

(57) ABSTRACT

Provided are a method of synchronizing data between a server and a user terminal using a messenger service system and a system using the same. In a data synchronization system including a messenger server for storing at least one contact list having information on terminals belonging to one messenger group, and a synchronization markup language (SyncML) server for synchronizing the information on the terminals, upon receiving a request for synchronization of information data to be shared by the group from a first terminal, the SyncML server stores the information data. Upon receiving an information data synchronization request from a second terminal, the Synch ML server requests the messenger server for a contact list of the second terminal. If it is determined that the second terminal belongs to the group to which the first terminal belongs, the SyncML server synchronizes the terminals with respect to the information data.

### PRIORITY

This application claims priority under 35 U.S.C. § 119 to an application entitled “Method of Synchronizing Data Between Server And User Terminal Using Messenger Service System And System Using The Same” filed in the Korean Intellectual Property Office on Mar. 12, 2004 and assigned Serial No. 2004-16835, and an application entitled “Method of Synchronizing Data Between Server And User Terminal Using Messenger Service System And System Using the Same” filed in the Korean Intellectual Property Office on Sep. 9, 2004 and assigned Serial No. 2004-72097, the contents of both of which are incorporated herein by reference.

### BACKGROUND OF THE INVENTION

1. Field of the Invention

The present invention relates generally to a data synchronizing method and system, and in particular, to a method of synchronizing data between a server and a user terminal using a messenger service system, and a system using the same.

2. Description of the Related Art

With the advancement of the wireless Internet, it is now common for users to search the Internet through a mobile data terminal and enjoy a data service by accessing an information provider's server. Recently, many users have begun to manage their schedules or exchange e-mails using a personal information management application installed in the mobile data terminal, not only for personal purposes but also for business purposes. In addition, with the diversification of a wireless mobile communication environment, various types of mobile terminals are now provided by vendors and the number of terminals in use has increased markedly. Therefore, it is necessary to harmonize (or synchronize) the same data distributed over the terminals with the latest one. Currently, to accomplish this data synchronization, Personal Data Assistant (PDA) manufacturers and service providers use their own synchronization protocols. A synchronization markup language (SyncML) is a standard language proposed to perform data synchronization in a particular network environment irrespective of types of terminals and services. A SyncML synchronization protocol defines a SyncML message exchanging method, an actual synchronization method, and a synchronization type in order to add, delete, and modify data between a SyncML server and a SyncML terminal.

FIG. 1 is a signaling diagram for performing data synchronization between a mobile terminal 160 performing a common SyncML client function (hereinafter referred to as a “SyncML terminal”) and a server 102 performing a SyncML server function (hereinafter referred to as a “SyncML server”). If the SyncML terminal 160 transmits a synchronization request message including modified data to the SyncML server 102 in step 104, the SyncML server 102 performs a data synchronization process based on a synchronization type requested by the SyncML terminal 160 and transmits a synchronization response message to the SyncML terminal 160 in step 106.

In a recently proposed SyncML service, a user of the SyncML terminal 160 generates personal information using the SyncML terminal 160 and stores the generated information in the SyncML server 102 for synchronization of the information. Accordingly, although the user can have a plurality of portable terminals, the user can always read the latest personal information from the SyncML server 102 with any one of the user's portable terminals.

Another data service, known as a messenger service, has a presence function of sharing current states of members enrolled in a contact list and a function of enabling a message exchange between the members. As portable terminals such as cellular phones, PDAs, and mobile personal computers (PCs) proliferate, the messenger service serves to group persons sharing common interests.

For data compatibility between a messenger terminal and a messenger server, each time they are connected to each other, data synchronization should be performed therebetween. FIG. 2 is a signaling diagram for synchronizing presence information between a messenger terminal 110 and a messenger server 112. Referring to FIG. 2, the messenger terminal 110 is a terminal supporting a messenger service, and it can access the messenger server 112 through an Internet network or a mobile communication wireless network. The messenger server 112 supporting the messenger service has a presence information database and stores therein presence information such as friend list information, state information of friends enlisted in a friend list, address information of the friends, and contact information of the messenger terminal 110. Here, the “presence information” refers to information data, such as friend list information, state information of friends enlisted in a friend list, address information of the friends, and contact information, which are stored in both the messenger terminal 110 and the messenger server 112 to provide the messenger service.

The messenger terminal 110 accesses the messenger server 112, transmits a presence information request to the messenger server 112 in order to receive the messenger service, and receives presence information from the messenger server 112 in response to the presence information request. Specifically, upon receiving a messenger service request from a user, the messenger terminal 110 transmits a login request signal to the messenger server 112 in step 200. The messenger server 112 determines that the messenger terminal 110 has transmitted the login request signal and transmits a response signal in response to the login request signal. Then, user service information and information on the messenger terminal 110 are exchanged between the messenger terminal 110 and the messenger server 112. Thereafter, in step 202, the messenger terminal 110 transmits a presence information request message GetPresenceRequest to the messenger server 112. In step 204, the messenger server 112 reads presence information for the messenger terminal 110 from the presence information database and transmits the read presence information to the messenger terminal 110.

As described above, the messenger service is provided for making a group of relevant persons and allowing the persons to share state information and exchange messages. However, when there is information to be shared by the members belonging to a group to which the messenger service is provided, the messenger service does not provide a separate method of distributing and synchronizing information, such as memo or schedule to be shared by terminals and the server. In addition, since the SyncML provides only a method of synchronizing simple information generated by an individual person between a server and a terminal, the SyncML also does not provide a method of sharing data with other members.

### SUMMARY OF THE INVENTION

An object of the present invention is to substantially solve at least the above problems and/or disadvantages and to provide at least the advantages below. Accordingly, an object of the present invention is to provide a system and method for providing and synchronizing information to be shared by members of a specific group using a contact list of a messenger service.

According to one aspect of the present invention, there is provided a data synchronization system including a messenger server for storing at least one contact list having information on terminals belonging to one messenger group, and a synchronization markup language (SyncML) server for synchronizing the information on the terminals. In the data synchronization system, if a synchronization request message including information data to be shared by the group is received from a first terminal, the SyncML server stores the information data and receives a contact list of a second terminal from the messenger server in response to an information data synchronization request from the second terminal, and if it is determined that the second terminal belongs to the group to which the first terminal belongs using the contact list, the SyncML server synchronizes the terminals with respect to the information data.

According to another aspect of the present invention, there is provided a data synchronization system including a messenger server for storing at least one contact list having information on terminals belonging to one messenger group, and a synchronization markup language (SyncML) server for synchronizing the information on the terminals. Upon receiving a request for synchronization of information data to be shared by the group from a first terminal, the SyncML server stores the information data. Upon receiving an information data synchronization request from a second terminal, the SyncML server requests from the messenger server a contact list of the second terminal, and if it is determined that the second terminal belongs to the group to which the first terminal belongs using the contact list received in response to the request, the SyncML server synchronizes the terminals with respect to the information data.

### BRIEF DESCRIPTION OF THE DRAWINGS

The above and other objects, features and advantages of the present invention will become more apparent from the following detailed description when taken in conjunction with the accompanying drawings in which:

FIG. 1 is a signaling diagram for performing data synchronization between a SyncML terminal and a SyncML server according to the prior art;

FIG. 2 is a signaling diagram for synchronizing presence information between a messenger terminal and a messenger server according to the prior art;

FIG. 3 is a diagram illustrating a system configuration for providing shared information and performing a data synchronization process according to a preferred embodiment of the present invention;

FIG. 4 is a flow diagram illustrating a process of performing data synchronization with a SyncML server due to generation or modification of information by a terminal according to a preferred embodiment of the present invention;

FIG. 5 is a flow diagram illustrating a process of performing data synchronization due to modification of information by a terminal according to a preferred embodiment of the present invention;

FIG. 6 is a flow diagram illustrating a data synchronization process in which a SyncML server selects a target terminal to which shared information is provided according to a preferred embodiment of the present invention;

FIG. 7 is a flow diagram illustrating a data synchronization process in which a messenger server selects a target terminal to which shared information is provided according to a preferred embodiment of the present invention;

FIG. 8 is a diagram illustrating a data format for storing data generated or modified by a terminal in the SyncML server according to a preferred embodiment of the present invention;

FIG. 9 is a diagram illustrating a data format of contact lists according to a preferred embodiment of the present invention; and

FIG. 10 is a diagram illustrating a data format of a contact list according to a preferred embodiment of the present invention.

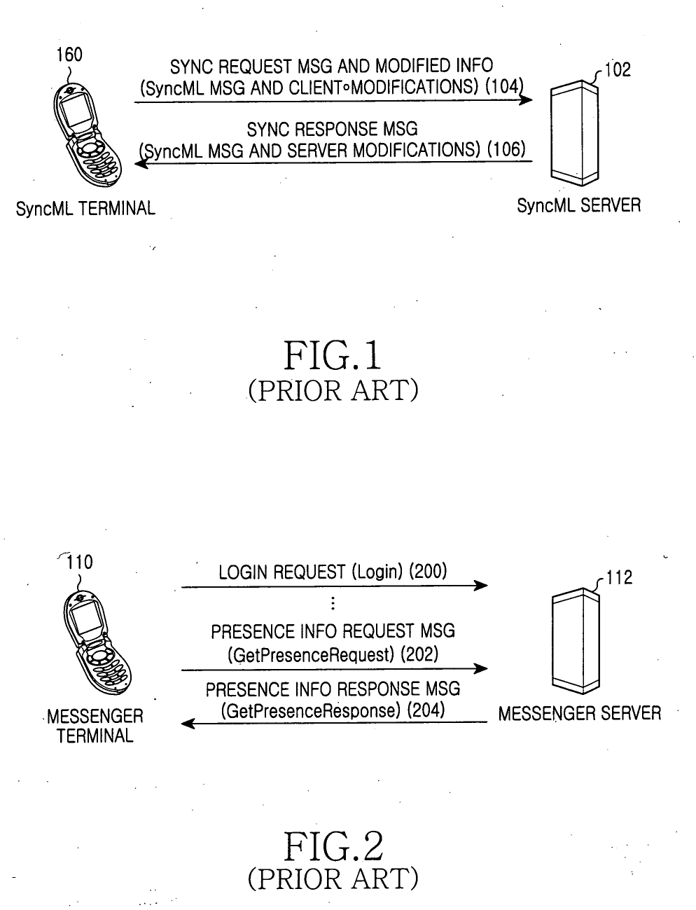

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

The present invention provides a function for information sharing among members belonging to a specific group. To this end, the present invention provides a data synchronizing method between a server and terminals using a synchronization markup language (SyncML), which is a standard protocol. The server is divided into a SyncML server, which provides shared information and a synchronization service, and a messenger server, which provides contact lists of user terminals for classifying groups to which shared information is provided.

In a preferred embodiment of the present invention, for the synchronization service in which generated or modified information is shared by members belonging to a specific group, the SyncML server updates a synchronization database in advance, each time new shared information is input. Thereafter, upon receiving a synchronization request from another user terminal, the SyncML server receives a contact list from the messenger server, authenticates the corresponding terminal, and performs data synchronization if the authentication is successful. That is, the preferred embodiment of the present invention supports SyncML server-oriented data synchronization.

In another preferred embodiment of the present invention, if a user terminal transmits a message indicating the necessity of updating shared information to the messenger server upon generation of new information, the messenger server transmits a contact list of a group to which the user terminal belongs to the SyncML server, and the SyncML server performs an updating process. That is, this preferred embodiment of the present invention supports messenger server-oriented data synchronization.

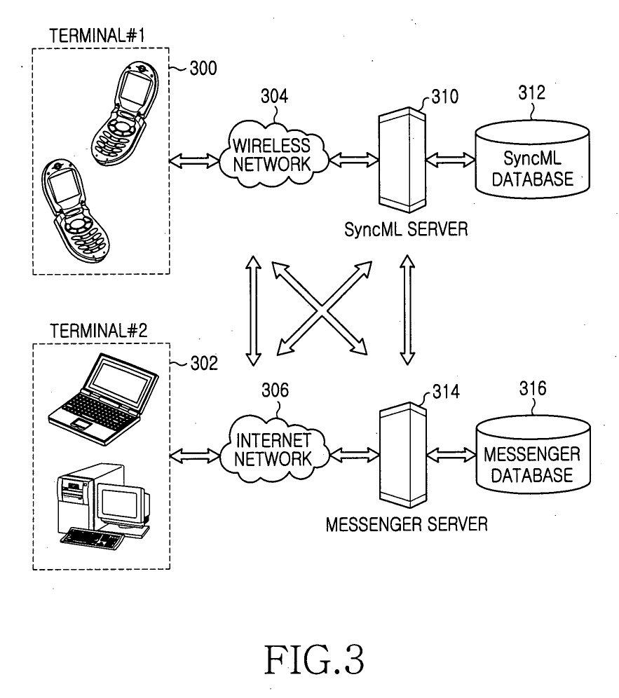

A system for providing synchronization service to member terminals in order to provide information to be shared by members belonging to a specific group will now be described with reference to FIG. 3. FIG. 3 is a diagram illustrating a system configuration for providing shared information and for performing a data synchronization process according to a preferred embodiment of the present invention.

Referring to FIG. 3, for a messenger service, a first terminal 300 and a second terminal 302, which are user terminals joined together in a contact list, are connected to a messenger server 314 and a SyncML server 310 through network interfacing with an Internet network 306 and a wireless network 304. The first terminal 300 and the second terminal 302 can access the messenger server 316 and the SyncML server 310 through the wired/wireless Internet.

The SyncML server 310 provides information to be shared and the synchronization service. Here, the information to be shared may include various types of information according to group characteristics, such as file, note, group notice, e-mail, vCalendar, vCard, etc. The information providing operation refers to an operation of providing information generated by a user terminal joined in a contact list with other terminals included in the contact list. The synchronization service refers to a service in which when the provided information is modified or deleted by another user terminal, the modification or deletion is equally applied to the remaining terminals or clients. For the information providing operation and the synchronization service, the messenger server 314 provides a contact list of a user terminal in response to a request from the SyncML server 310, and the SyncML server 310 authenticates the user terminal using the contact list received from the messenger server 314 and performs synchronization if the authentication is successful.

It is assumed for purposes of explanation in FIG. 3 that the first terminal 300 generates and modifies information to be shared, and the second terminal 302 receives the shared information.

The SyncML server-oriented data synchronization process will now be described. Upon receiving information to be shared by subscribers or a synchronization request to the SyncML server 310, the first terminal 300 performs data synchronization with the SyncML server 310 using a SyncML protocol. After this, when the second terminal 302 tries to perform data synchronization with the SyncML server 310, the SyncML server 310 sends a request to the messenger server 314 for a contact list to determine a group to which the shared information is provided. That is, the SyncML server 310 authenticates whether the second terminal 302 has joined a group to which the first terminal 300 belongs using the messenger server 314, and if the second terminal 302 is also a member of the group, the SyncML server 310 provides the shared information to the second terminal 302.

A description will now be made of a signaling flow between the first and second terminals 300 and 302, the SyncML server 310, and the messenger server 314 to provide information to be shared by members belonging to a specific group in the system configuration shown in FIG. 3, for the synchronization service between member terminals.

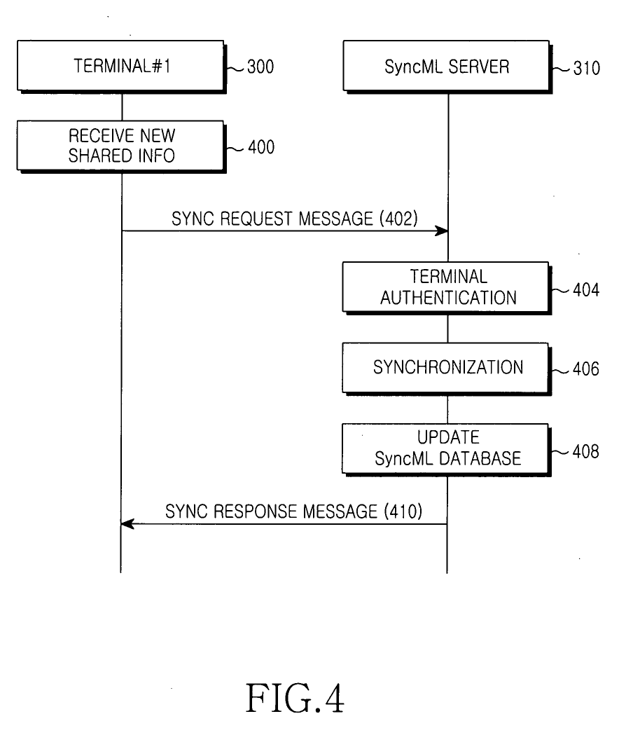

A flow diagram illustrating a process of performing data synchronization with a SyncML server due to generation or modification of information by a terminal according to a preferred embodiment of the present invention is shown in FIG. 4. Upon receiving information to be shared by subscribers or a synchronization request to the SyncML server 310 in step 400, the first terminal 300 transmits a synchronization request message to the SyncML server 310 using the SyncML protocol in step 402. Here, the synchronization request message includes generated or modified information.

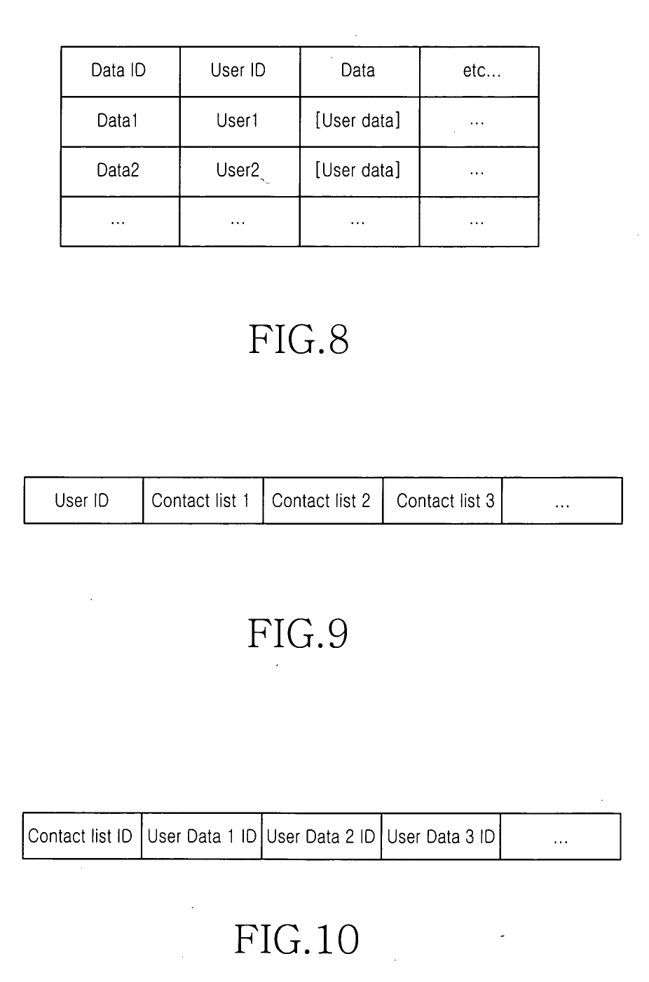

Upon receiving the synchronization request message from the first terminal 300, the SyncML server 310 performs in step 404 an authentication process on the first terminal 300 that has transmitted the message, and then proceeds to step 406. In step 406, the SyncML server 310 performs a data synchronization process with the first terminal 300, and then proceeds to step 408. In step 408, the SyncML server 310 updates a SyncML database 312, i.e., stores the generated or modified information data in the SyncML database 312. A data format of the generated or modified information data stored in the SyncML database 312 is shown in FIG. 8.

A diagram illustrating a data format for storing data generated or modified by a terminal in the SyncML server 310 according to a preferred embodiment of the present invention is shown in FIG. 8. As illustrated, identifications (IDs) of information data to be shared, user IDs, and user data are stored in the SyncML database 312. After updating the SyncML database 312, the SyncML server 310 transmits a synchronization response message to the first terminal 300 in step 410.

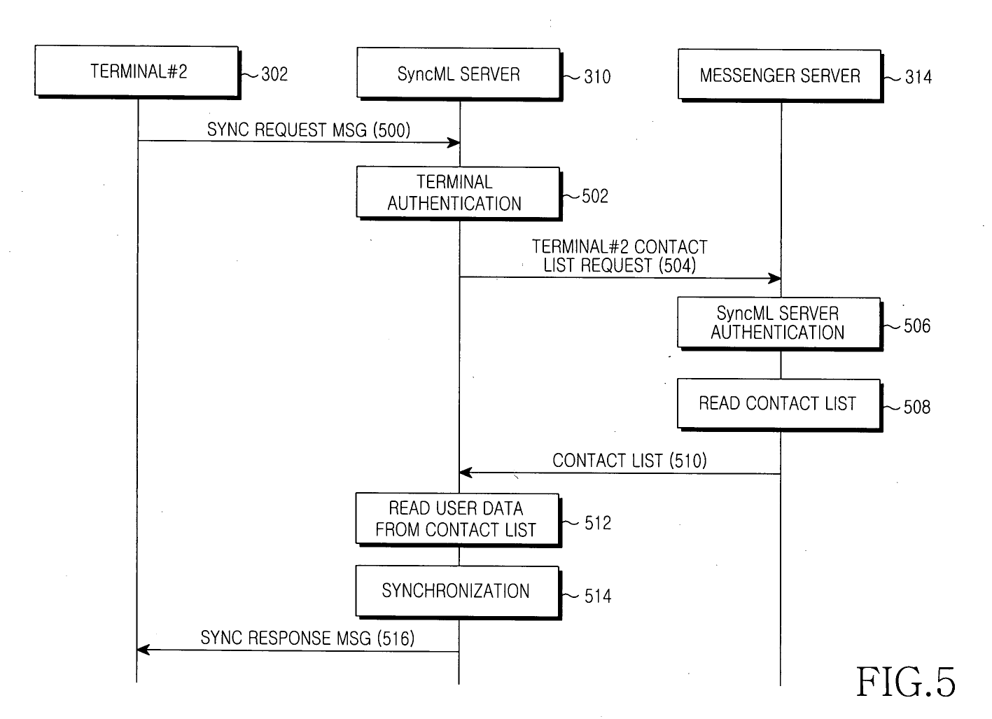

With reference to FIG. 5, a description will now be made of a process in which the SyncML server 310 provides the information generated or modified by the first terminal 300 to group members when the group members perform the data synchronization process with the SyncML server 310 after the first terminal 300 has performed the data synchronization process with the SyncML server 310 with respect to the information to be shared by the group members.

A flow diagram illustrating a process of performing data synchronization due to modification of information by a terminal according to a preferred embodiment of the present invention is shown in FIG. 5. In step 500, the second terminal 302 transmits a synchronization request message to the SyncML server 310. In step 502, the SyncML server 310 receiving the synchronization request message performs a terminal authentication process. In step 504, the SyncML server 310 requests the messenger server 314 for a contact list of the second terminal 302. In step 506, the messenger server 314 receiving the contact list request message performs a SyncML server authentication process. Thereafter, in step 508, the messenger server 314 reads a corresponding contact list. In step 510, the messenger server 314 transmits the read contact list to the SyncML server 310. In summary, the SyncML server 310 transmits a contact list request to the messenger server 314 and determines a group to which information generated or modified by the first terminal 300 is provided, using the contact list provided from the messenger server 314. Here, an example of contact lists of a user terminal is shown in FIG. 9. That is, the contact lists identify groups to which shared information, which is generated or modified information, is provided.

In step 512, the SyncML server 310 receiving the contact list reads user data from the received contact list. Thereafter, the SyncML server 310 performs a data synchronization process in step 514, and transmits a synchronization response message to the second terminal 302 in step 516. In summary, the SyncML server 310 reads user data included in a corresponding contact list and performs the data synchronization process with the read user data. An example of the contact list is shown in FIG. 10.

As described above, in the embodiment of the present invention, after one member of a group is synchronized with the SyncML server 310 with respect to information to be shared by the group members, when another user requests the SyncML server 310 for synchronization, the SyncML server 310 authenticates whether the corresponding user is a member of the group using the messenger server 314 and transmits the information to be shared to the corresponding user if the authentication is successful.

Next, a description will be made of the messenger server-oriented data synchronization process according to another preferred embodiment of the present invention. This embodiment provides a synchronizing method for a SyncML server supporting a synchronization announcement function and a SyncML server not supporting the synchronization announcement function.

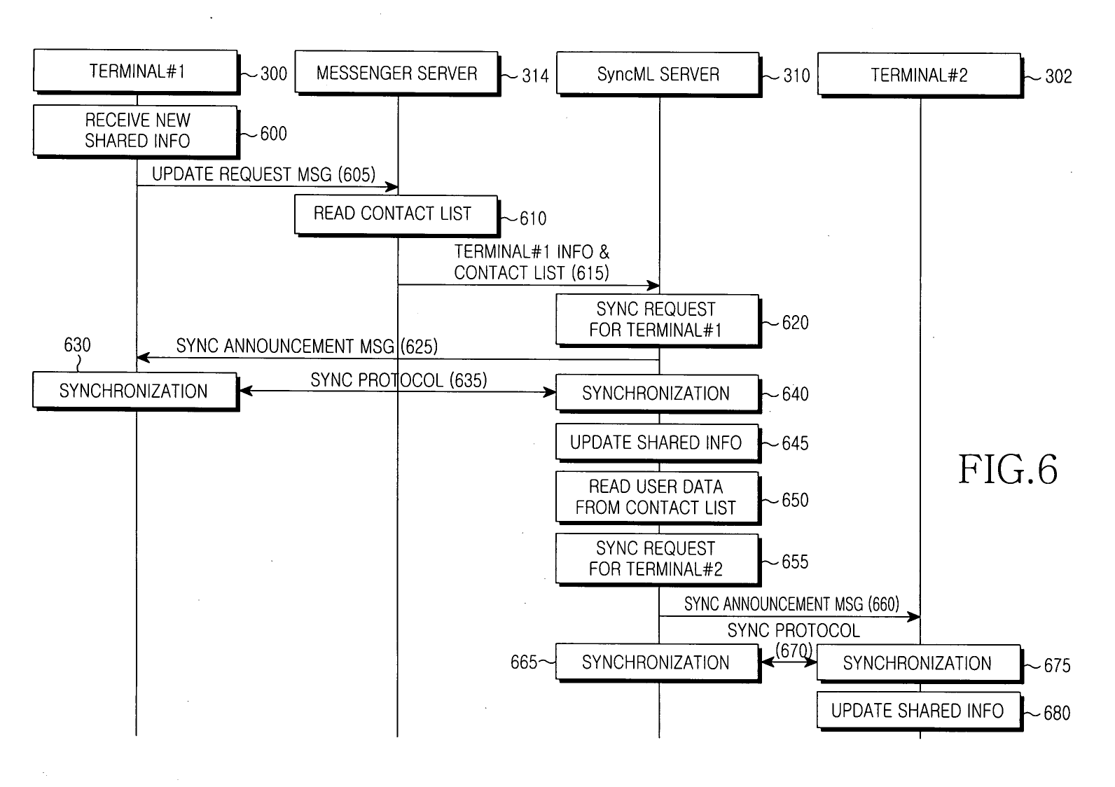

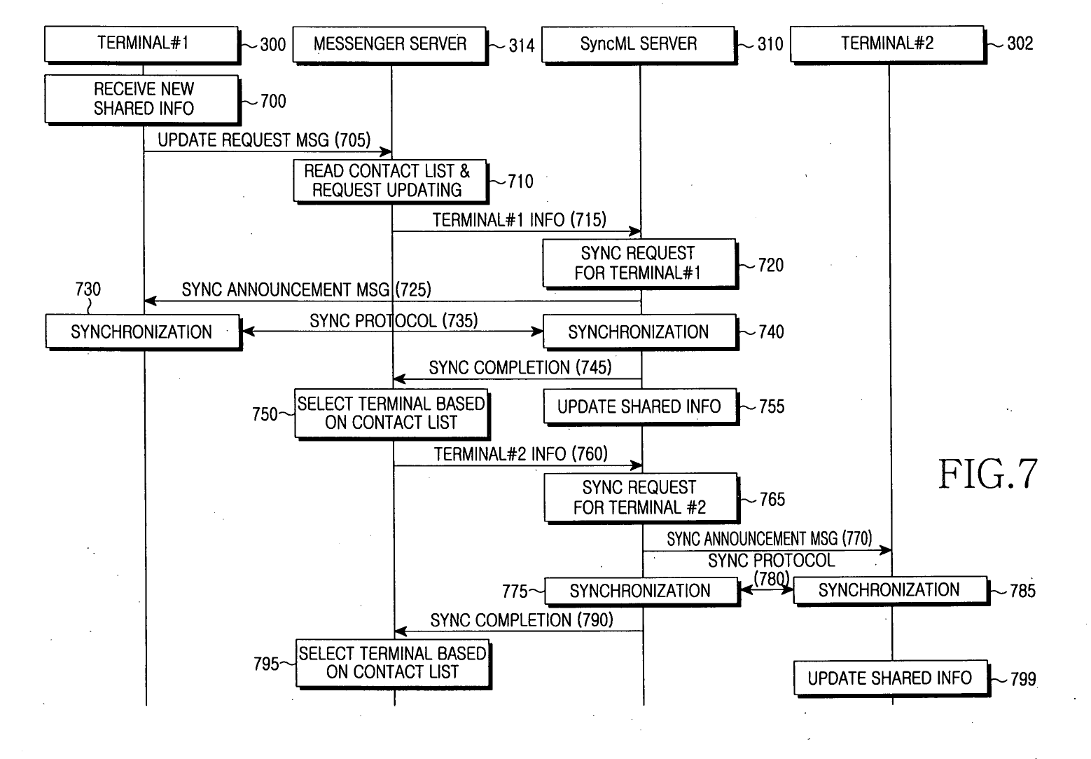

Two possible different synchronizing methods for the SyncML server supporting the synchronization announcement function will be described with reference to FIGS. 6 and 7.

With reference to FIG. 6, a description will now be made of a data synchronization process in which the messenger server 314 provides a contact list to the SyncML server 310.

A flow diagram illustrating a data synchronization process in which the SyncML server 310 selects a target terminal to which shared information is provided according to a preferred embodiment of the present invention is shown in FIG. 6. If new shared information is input to the first terminal 300 by a user, that is, if information to be shared by members belonging to a specific group is generated in step 600, the first terminal 300 transmits an update request message indicating the necessity of updating shared information to the messenger server 314 in step 605. In step 610, the messenger server 314 reads contact lists of the first terminal 300 which has transmitted the update request message, and a group to which the first terminal 300 belongs, in response to the received update request message. In step 615, the messenger server 314 transmits the read contact lists and information on the first terminal 300 to the SyncML server 310. Here, the SyncML server 310, receiving the read contact lists and information on the first terminal 300, supports the synchronization announcement function for the first terminal 300. Thus, in step 620, the SyncML server 310 requests for synchronization with the first terminal 300 (i.e., the SyncML server 310 generates a synchronization announcement message). In step 625, the SyncML server 310 transmits the generated synchronization announcement message to the first terminal 300.

The first terminal 300 and the SyncML server 310, between which a SyncML protocol is applied in step 635, perform the synchronization in steps 630 and 640, respectively. The SyncML server 310 performs the synchronization after authenticating the first terminal 300. Here, the synchronization using the SyncML protocol in step 635 is achieved by transmitting the information generated or modified by the first terminal 300 to the SyncML server 310.

After performing the synchronization with the first terminal 300, the SyncML server 310 updates the shared information in step 645. That is, the SyncML server 310 stores the generated or modified information in the SyncML database 312, thereby updating the SyncML database 312. Here, a data format in which the shared information is stored in the SyncML database 312 is shown in FIG. 8.

In step 650, the SyncML server 310 reads user information from the contact list received from the messenger server 314. That is, the SyncML server 310 selects a group to which the shared information is provided using the contact list in order to transmit the shared information to members belonging to the group to which the first terminal 300 belongs. As a result of the selection, in step 655, the SyncML server 310 requests synchronization with the second terminal 302 to which the shared information is provided (i.e., the SyncML server 310 generates a synchronization announcement message indicating the presence of the updated shared information). In step 660, the SyncML server 310 transmits the generated synchronization announcement message to the second terminal 302.

The SyncML server 310 and the second terminal 302, between which the SyncML protocol is applied in step 670, perform the synchronization in steps 665 and 675, respectively. In step 680, the second terminal 302 updates shared information stored therein.

In brief, in the case where the synchronization announcement function is supported by the SyncML server 310, if a terminal which is a member of a group transmits to the SyncML server 310 an update request message indicating the necessity of updating shared information, the SyncML server 310 receives a contact list from the messenger server 314, performs synchronization with the terminal, and transmits a synchronization announcement message to the group members to perform synchronization with the other terminals belonging to the group.

With reference to FIG. 7, a description will now be made of a data synchronization process in which the messenger server 314 selects a target terminal to which shared information is provided and provides information on the selected target terminal to the SyncML server 310.

A flow diagram illustrating a data synchronization process in which a messenger server selects a target terminal to which shared information is provided according to a preferred embodiment of the present invention is shown in FIG. 7. If new shared information is input to the first terminal 300 by a user in step 700, the first terminal 300 transmits an update request message indicating the necessity of updating shared information to the messenger server 314 in step 705. In step 710, the messenger server 314 reads a contact list of the first terminal 300 and requests the SyncML server 310 for updating of the SyncML database 312 in step 710. In step 715, the messenger server 314 transmits information on the first terminal 300 to the SyncML server 310. In step 720, the SyncML server 310 requests synchronization with the first terminal 300 using the information received from the messenger server 314. In step 725, the SyncML server 310 generates a synchronization announcement message for the synchronization request and transmits the generated synchronization announcement message to the first terminal 300. The first terminal 300 and the SyncML server 310, between which the SyncML protocol is applied in step 735, perform the synchronization in steps 730 and 740, respectively. The SyncML server 310 informs the messenger server 314 of completion of the synchronization in step 745, and updates the shared information (i.e., the SyncML database 312), in step 755. When the messenger server 314 recognizes the completion of the synchronization, it reads the contact list of the first terminal 300 and selects a target terminal to be updated based on the contact list in step 750. That is, the messenger server 314 determines a group to which the information generated or modified by the first terminal 300 is provided. For example, if the second terminal 302 is selected as the target terminal, the messenger server 314 transmits information on the second terminal 302 to the SyncML server 310 in step 760.

In step 765, the SyncML server 310 requests synchronization with the second terminal 302 (i.e., the SyncML server 310 generates a synchronization announcement message). In step 770, the SyncML server 310 transmits the generated synchronization announcement message to the second terminal 302. In step 775, the SyncML server 310 performs synchronization in which the information to be shared is transmitted to the second terminal 302. In step 785, the second terminal 302, receiving the synchronization announcement message, performs synchronization with the SyncML server 310 using the SyncML protocol 780. Thereafter, in step 799, the second terminal 302 updates shared information stored therein. If the SyncML server 310 completes the synchronization, it transmits a synchronization completion message to the messenger server 314 in step 790. In step 795, the messenger server 314 selects another target terminal to be updated on the basis of the contact list to perform the data synchronization process with other terminals as described above. In this manner, information can be shared by the members included in the contact list.

In brief, in the case where the synchronization announcement function is supported by the messenger server 314, the messenger server 314 selects target terminals to which the shared information is provided and transmits information on the selected target terminals to the SyncML server 310, thereby enabling synchronization between group members.

A description will now be made of a data synchronization method in which the synchronization announcement function is not supported by the SyncML server 310 according to another preferred embodiment of the present invention.

If the synchronization announcement function is not supported by the SyncML server 310, the messenger server 314 directly transmits a message indicating the presence of information to be shared to each of members included in a contact list. That is, when the SyncML server 310 cannot support a function of providing the shared information using the contact list, the messenger server 314 informs the group members of an update of the shared information.

That is, when the messenger server 314 transmits to each terminal of the group members a message indicating the presence of information generated or modified by a specific terminal in the same group (i.e., information to be shared, in the SyncML server 310), the terminals of the group members can receive the updated shared information by performing the synchronization with the SyncML server 310.

As described above, when there is information to be shared by members included in a group to which a messenger service is provided, the present invention can separately distribute and synchronize the information to be shared, such as a memo or vCalendar information, using a terminal or server. In addition, a synchronization markup language (SyncML) enables not only synchronization of simple information generated by an individual person between the terminal and the server but also sharing of the information with other users.

While the invention has been shown and described with reference to certain preferred embodiments thereof, it will be understood by those skilled in the art that various changes in form and details may be made therein without departing from the spirit and scope of the invention as defined by the appended claims.

1. A data synchronization system including a messenger server for storing at least one contact list having information on terminals belonging to a messenger group, and a synchronization markup language (SyncML) server for synchronizing the information on the terminals,
wherein the SyncML server stores the information data and receives a contact list of a second terminal from the messenger server in response to an information data synchronization request from the second terminal, if a synchronization request message including information data to be shared by the group is received from a first terminal; and the SyncML server synchronizes the terminals with respect to the information data, if it is determined that the second terminal belongs to the group to which the first terminal belongs using the contact list.

2. The system of claim 1, wherein the information data includes at least one of a file, a note, a group notice information, an e-mail, a calendar, and a card.

3. The system of claim 1, wherein the information data synchronization with the second terminal by the SyncML server is achieved by providing information data generated, modified, or deleted by the first terminal to the second terminal.

4. A method for a synchronization markup language (SyncML) server to perform data synchronization with terminals belonging to a messenger group in a data synchronization system including a messenger server for storing at least one contact list having information on the terminals, and the SyncML server for synchronizing the information on the terminals, the method comprising the steps of:
storing the information data upon receiving a request for synchronization of information data to be shared by the group from a first terminal;
requesting the messenger server for a contact list of the second terminal upon receiving an information data synchronization request from a second terminal;
determining whether the first terminal and the second terminal belong to the same group through the use of the contact list received in response to the request; and
synchronizing the terminals with respect to the information data, if it is determined that the first terminal and the second terminal belong to the same group.

5. The method of claim 4, wherein the information data includes at least one of a file, a note, a group notice information, an e-mail, a calendar, and a card.

6. The method of claim 4, wherein the step of synchronizing the terminals with respect to the information data according to whether the first and second terminals belongs to the same group includes the step of providing information data which is generated, modified, or deleted by the first terminal to the second terminal.

7. A data synchronization system including a messenger server for storing at least one contact list having information on terminals belonging to a messenger group, and a synchronization markup language (SyncML) server for synchronizing the information on the terminals,
wherein if a shared information update request message is received from a first terminal, the messenger server transmits a contact list read for the first terminal and information on the first terminal to the SyncML server, and the SyncML server performs synchronization with the first terminal using the information on the first terminal, stores shared information from the first terminal, and sequentially performs the synchronization with terminals included in the contact list.

8. The system of claim 7, wherein the shared information is information which is generated, modified, or deleted by the first terminal and includes at least one of a file, a note, a group notice information, an e-mail, a calendar, and a card.

9. A data synchronization system including a messenger server for storing at least one contact list having information on terminals belonging to a messenger group, and a synchronization markup language (SyncML) server for synchronizing the information on the terminals,
wherein if the messenger server transmits information on a first terminal to the SyncML server in response to a shared information update request from the first terminal, the SyncML server performs synchronization with the first terminal, stores shared information, and informs the messenger server of completion of the synchronization, and if information on a target terminal based on a contact list of the first terminal is received from the messenger server, the SyncML server performs the synchronization with the target terminal with respect to the shared information.

10. The system of claim 9, wherein the shared information is information which is generated, modified, or deleted by the first terminal and includes at least one of a file, a note, a group notice information, an e-mail, a calendar, and a card.

11. A method for a synchronization markup language (SyncML) server to perform data synchronization with terminals belonging to a messenger group in a data synchronization system including a messenger server for storing at least one contact list having information on the terminals, and the SyncML server for synchronizing the information on the terminals, the method comprising the steps of:
receiving, by the messenger server, a shared information update request message from a first terminal belonging to the messenger group;
transmitting a contact list of the first terminal and information on the first terminal to the SyncML server in response to the request message; and
performing, by the SyncML server, synchronization with the first terminal using the information on the first terminal, and storing shared information from the first terminal.

12. The method of claim 11, further comprising the step of sequentially performing, by the SyncML server, the synchronization with terminals included in the contact list of the first terminal using the contact list.

13. A method for a synchronization markup language (SyncML) server to perform data synchronization with terminals belonging to one messenger group in a data synchronization system including a messenger server for storing at least one contact list having information on the terminals, and the SyncML server for synchronizing the information on the terminals, the method comprising the steps of:
receiving, by the messenger server, a shared information update request message from a first terminal belonging to the messenger group;
transmitting, by the messenger server, information on the first terminal to the SyncML server in response to the request message; and
performing, by the SyncML server, synchronization with the first terminal using the information on the first terminal, and storing shared information.

14. The method of claim 13, further comprising the steps of:
storing, by the SyncML server, the shared information and informing the messenger server of completion of the synchronization;
selecting a target terminal based on a contact list of the first terminal and transmitting information on the selected target terminal to the SyncML server, if the messenger server recognizes the completion of the synchronization; and
performing, by the SyncML server, synchronization with the target terminal using the information on the selected target terminal.

15. The method of claim 13, wherein the step of performing, by the SyncML server, synchronization with the first terminal comprises the steps of:
receiving shared information which is generated, modified or deleted by the first terminal; and
updating information to be shared by the terminals belonging to the messenger group with the shared information received from the first terminal.
